(19) United States
(12) Patent Application Publication
(10) Pub. No.: US 2026/0311187 A1
(43) Pub. Date: Oct. 8, 2026

(54) NONVERBAL TRANSACTION CONTROL

(71) Applicant: Wells Fargo Bank, N.A., San Francisco, CA (US)

(72) Inventors: Marc Le Boeuf, Menlo Park, CA (US); Dennis E. Montenegro, Concord, CA (US); Sadie Salim, Mill Valley, CA (US); Ramesh Yarlagadda, Charlotte, NC (US)

(21) Appl. No.: 19/172,887

(22) Filed: Apr. 8, 2025

(51) Int. Cl. G06Q 20/42; G06F 3/01; G06Q 20/40

(52) U.S. Cl. CPC G06Q 20/42; G06F 3/017; G06Q 20/4015

(57) ABSTRACT

An example system for processing a transaction can include: at least one processor; and memory encoding instructions which, when executed by the at least one processor, causes the system to: detect, by a wearable device, a nonverbal gesture directed at a payment object; determine, by the wearable device after detection of the nonverbal gesture, payment information based on computer vision analysis of the payment object; request, by the wearable device, a confirmation gesture; and process the transaction in response to the confirmation gesture.

### BACKGROUND

lectronic payment systems continue to evolve as technology advances, with traditional point-of-sale terminals and standard payment commands becoming increasingly cumbersome in modern retail environments. While various payment technologies exist, including contactless payments, current solutions often require verbal and/or physical interactions with payment devices, which can create social friction and slow down transaction processing.

### SUMMARY

In one aspect, an example system for processing a transaction can include: at least one processor; and memory encoding instructions which, when executed by the at least one processor, causes the system to: detect, by a wearable device, a nonverbal gesture directed at a payment object; determine, by the wearable device after detection of the nonverbal gesture, payment information based on computer vision analysis of the payment object; request, by the wearable device, a confirmation gesture; authenticate a user through detection of the confirmation gesture; and process the transaction upon successful authentication.

In another aspect, an example method for processing a transaction can include: detecting, by a wearable device, a nonverbal gesture directed at a payment object; determining, by the wearable device after detection of the nonverbal gesture, payment information based on computer vision analysis of the payment object; requesting, by the wearable device, a confirmation gesture; authenticating a user through detection of the confirmation gesture; and processing the transaction upon successful authentication.

### DESCRIPTION OF THE DRAWINGS

FIG. 1 shows an example system that provides for nonverbal control of financial transactions.

FIG. 2 shows details of an example wearable device of the system of FIG. 1.

FIG. 3 shows example point of sale and payment object configurations of the system of FIG. 1.

FIG. 4 shows an example flow diagram of payment initiation and completion using the system of FIG. 1.

FIG. 5 shows an example flow diagram including gesture detection and fraud prevention measures implemented by the system of FIG. 1.

FIG. 6 shows example physical components of the wearable device of FIG. 2.

### DETAILED DESCRIPTION

The present disclosure is directed to the nonverbal control of financial transactions.

Example systems are provided herein for devices that enable users to initiate payments using nonverbal cues directed at objects like point-of-sale (POS) terminals, bills, menus, persons, establishments, and/or physical items. The systems can use cameras or other vision components to determine payment information through methods like quick-response (QR) code reading, optical character recognition (OCR), and object recognition, while leveraging other information (e.g., geolocation and vendor application programming interfaces (APIs)) to complete transaction details. A user can initiate and/or confirm payments through nonverbal gesture-based interactions, like a thumbs up, nod/shake of head, and/or or palm authentication, with built-in fraud prevention features that verify device locations and vendor attributes.

The examples provided herein are generally described for devices that may be worn or carried by a user. Examples of such devices include, without limitation, various wearable devices equipped with cameras. One such wearable device is a pair of smart glasses, like the Ray-Ban Meta AI glasses from Meta of Menlo Park, California, which incorporate cameras, microphones, and speakers without visual displays. Beyond smart glasses, the point-to-pay functionality extends to pocket-clipped devices, pendant-style wearables, and lapel-mounted artificial intelligence (AI) devices that can process visual inputs and provide responses through connected headphones or smartwatch displays like smartphones or tablet computers.

The examples provided herein can operate on any wearable camera form factor that supports computer vision capabilities, including devices with advanced features (e.g., time-of-flight (ToF) sensors, depth sensors, and/or dual-camera configurations) that enable enhanced authentication through Infrared (IR) cameras and stereo vision calculations. Additional compatible devices include gloves, watches, and headphones equipped with cameras, with the examples being device-agnostic as long as the wearable includes vision capabilities for detecting nonverbal gestures and processing visual payment information.

In some examples provided herein, the wearable device is configured to interact with the user without using a display or providing visual feedback. For instance, as provided herein, the wearable device can utilize non-visual stimuli, like haptic feedback (vibrations, pressure, or twisting sensations), audio cues (beeps, tones, or spoken alerts), and/or changes in temperature or electrical stimulation, to provide feedback to the user during the transaction process. This means, in some embodiments, the wearable device does not include a display or otherwise display information to the user. In optional alternative embodiments, the wearable device can also include augmented reality devices, virtual reality devices, and/or other devices that provide visual feedback to the user.

The wearable device can include wireless telecommunication capabilities, permitting a wireless connection between the wearable device and one or more server computers. The wearable device can, in some embodiments, also include voice recognition capability, permitting the user to direct the wearable device via voice commands. In addition, in some implementations, the wearable device includes biometric capability such as facial recognition, retinal scan capability, fingerprint, palm, and voice print capability.

The disclosed technologies provide a practical solution to the technical challenge of enabling secure, low friction, and/or private payment transactions through wearable devices by implementing specialized computer vision and artificial intelligence systems. The technology integrates multiple technical components, including camera-based gesture detection, machine learning models for QR code segmentation, real-time computer vision processing, and/or biometric authentication to minimize fraudulent transactions. These technical elements work together to improve the security and efficiency of electronic payment systems while reducing computational overhead through selective camera activation and targeted frame processing.

The disclosed embodiments further demonstrate practical applications through the implementation of fraud prevention measures that leverage multiple technical subsystems working in concert, including geolocation verification, proximity sensors, and visual scene validation. The technologies can further employ specialized machine learning models to calculate hand angles and gestures relative to a field of view, while simultaneously processing multiple data streams including global positioning system (GPS) coordinates, device telemetry, and real-time visual inputs to ensure transaction security. This technical integration enables the system to overcome the limitations of traditional payment systems by providing a secure, efficient method for processing transactions without requiring verbal commands or physical contact with payment terminals.

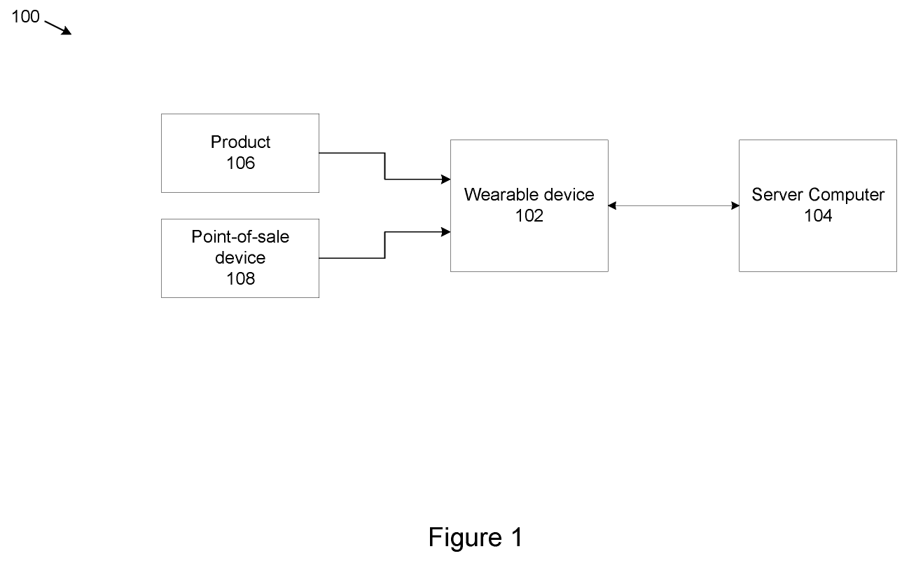

FIG. 1 shows an example system 100 that supports the nonverbal control of financial transactions. In this embodiment, the system 100 includes a wearable device 102, a server computer 104, a product 106, and a point-of-sale device 108.

The wearable device 102 can comprise one or more cameras that are capable of capturing visual information to enable point-to-pay functionality, with the ability to detect nonverbal gestures, read QR codes, and/or perform optical character recognition. The wearable device 102 can take various form factors including smart glasses, pocket clips, pendants, or lapel-mounted cameras, and may incorporate advanced features such as ToF sensors, depth sensors, or dual-camera configurations for enhanced gesture capture and authentication capabilities. The wearable device 102 operates to optimize battery life while maintaining responsive gesture detection and authentication.

The server computer 104 can process payment information by interfacing with vendor APIs to obtain transaction details, validate payment methods through financial institution APIs, and coordinate fraud prevention measures. Other APIs could also be used, such as for e-commerce attributes like inventory, pricing, employee identification, etc. The server computer 104 manages the authentication workflow (e.g., palm biometric validation) and can store encrypted biometric data. The server computer 104 also validates transaction security by verifying geolocation data, checking device proximity, and/or confirming vendor attributes against known databases.

The product 106 can be any item or service available for purchase or sale, which the system 100 identifies through various methods depending on the scenario. For physical items, the system 100 can detect price tags or RFID tags, while for restaurant scenarios, the system 100 can perform OCR on menus or bills. The system 100 can also identify establishments directly through visual recognition of business names and validate locations through geolocation services.

The point-of-sale device 108 facilitates payment processing through multiple interaction methods including dynamic QR code display, static printed QR codes, or wireless connectivity via Bluetooth, NFC, Wi-Fi, or similar technologies. The point-of-sale device 108 can display customized payment indicators during transactions, embedding unique transaction IDs that allow the server computer 104 to associate batched sales with specific customers. For permanent store setups, the point-of-sale device 108 works in conjunction with positioning and proximity data to enable seamless vendor identification and payment processing.

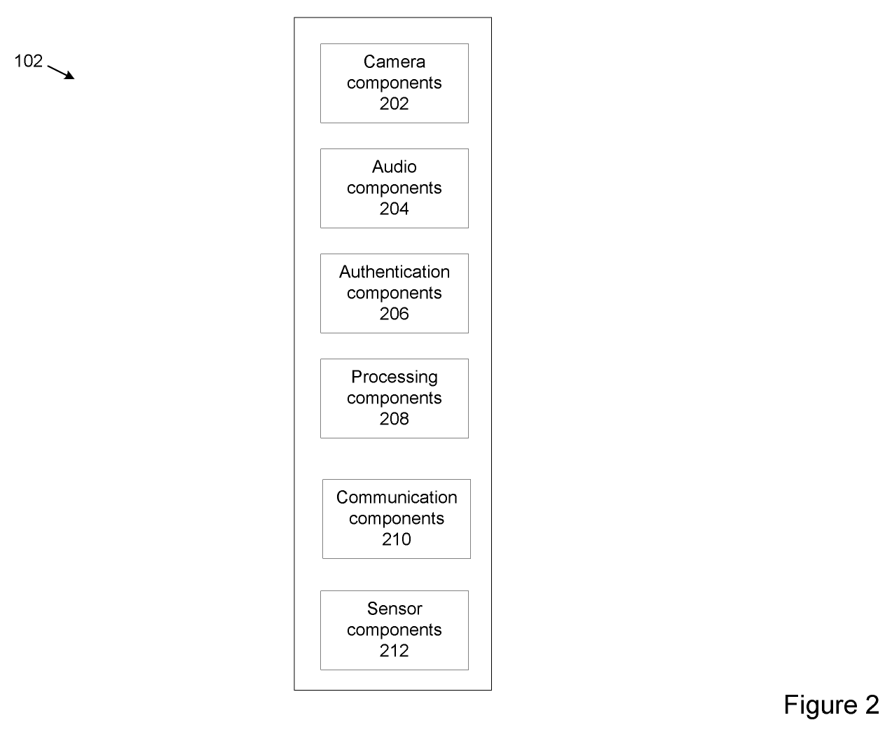

FIG. 2 shows details of the example wearable device 102 of the system 100 of FIG. 1. In this embodiment, the wearable device 102 is a pair of smart glasses including camera components 202, audio components 204, authentication components 206, processing components 208, communication components 210, and sensor components 212. Other configurations with additional or different components are possible. Further, as noted, the wearable device 102 can take many other forms.

The camera components 202 can include a primary camera capable of capturing visual information for enabling point-to-pay functionality. In one example, the camera components 202 operate at a specified rate (e.g., 2-4 frames per second) during payment sessions to optimize battery life while maintaining responsive detection capabilities for nonverbal gestures, QR codes, and OCR. For example, the camera components 202 can be configured to capture nonverbal gestures made by the user, such as physical gestures like pointing or thumbs up, to initiate and/or confirm a financial transaction. For enhanced authentication capabilities, the camera components 202 may include a dual-camera configuration with ToF or depth sensors to enable more accurate stereo vision calculations.

The audio components 204 can comprise speakers for providing private audio feedback to the user during payment transactions and a microphone for optional voice interactions. The speakers deliver confirmation sounds and payment prompts, such as asking “Do you want to pay $12.34 to Macy’s?”, while maintaining user privacy through directed audio. The audio components 204 can deliver such prompts through specialized speakers (e.g., bone conduction and/or directional) designed to maintain user privacy in public spaces, ensuring that sensitive transaction details remain confidential.

The authentication components 206 includes specialized sensors for enhanced security features, such as palm recognition, to authenticate and/or authorize a transaction. This may incorporate IR cameras for palm vein pattern detection and/or depth sensors for accurate palm positioning and spoofing prevention. The authentication components 206 can work in conjunction with the camera components 202 to validate nonverbal gestures and perform biometric verification during the initial setup and subsequent payment sessions. Other types of biometric indicators can also be used, such as fingerprints, facial recognition, voice recognition, iris recognition, and/or finger vein patterns.

More specifically, the authentication components 206 components of the wearable device 102 can allow the wearable device 102 to calculate precise hand angles and detect nonverbal gestures during payment sessions. A palm scanning configuration of the authentication components 206 may incorporate IR cameras specifically designed for palm vein pattern detection, working in conjunction with depth sensors to ensure accurate palm positioning and prevent spoofing attempts

During initial setup, the authentication components 206 of the system 100 capture baseline palm measurements when the user holds their palm in-line with the camera components 202 of the wearable device 102, using audio cues to guide proper positioning. An optional biometric sensor enables the system 100 to capture both palm prints and palm vein patterns through a combination of visible light and IR sensing.

The authentication components 206 works seamlessly with the camera components 202 to validate user gestures and perform biometric verification during both the initial setup process and subsequent payment sessions. The system 100 can store encrypted biometric data in the cloud and/or on the user’s mobile device for enhanced privacy.

More specifically, the initial setup process for the wearable device 102 can include a comprehensive palm measurement protocol to establish baseline biometric data. During setup, the user takes multiple pictures of their hands with the wearable device 102, providing audio cues to guide proper positioning, specifically instructing the user to move their palm closer or further away until it properly aligns with the baseline measurement parameters.

The system 100 can request the user to fully stretch out their arms in front of them during the setup process to establish accurate measurement parameters for gesture detection. This arm extension process helps the system 100 calculate the range of distance and angle measurements that will be used to identify valid pointing gestures and reduce false-positive detections during regular use.

For enhanced measurement accuracy, the system 100 can optionally utilize a credit card as a common reference object during the setup process. The inclusion of this standardized object allows the system 100 to calibrate its measurements more precisely for gesture detection and authentication purposes. The setup data is processed through both the camera components 202 of the wearable device 102, with IR and/or depth sensors of the wearable device 102 or other associated device capturing additional biometric data including palm print and palm vein patterns for future authentication use.

The setup process can, in some embodiments, leverage multiple hardware components, including the IR camera and depth sensors, to create a comprehensive biometric profile that enables sophisticated anti-spoofing measures. The machine learning models of the system 100 can use the captured baseline measurements to calculate hand angles relative to the camera’s field of view and validate subsequent gestures during payment transactions. For instance, a unique “arc” in which the user raises her arm and points a finger can be itself a biometric attribute. Other example “biometric” attributes can be the way the user nods or shakes her head, or other attributes such as the user’s gait, typing cadence, mouse movement, etc. Many configurations are possible.

The optional multi-camera setup incorporates dual cameras with ToF or IR sensors to enable enhanced authentication capabilities through stereo vision calculations. This configuration provides more accurate depth measurements for identifying valid gestures and performing initial measurements during setup. The dual-camera system also enables more sophisticated palm authentication by combining IR imaging for vein pattern detection with depth sensing for enhanced security.

The processing components 208 can execute computer vision AI and machine learning models for detecting nonverbal gestures and/or payment objects. These processing components 208 can run specialized algorithms for hand angle calculations, gesture recognition, and QR code segmentation, while managing the authentication workflow and payment processing tasks. The processing components 208 can optimize performance by selectively activating components during payment sessions to maintain efficient operation.

More specifically, the processing components 208 may employ specialized machine learning language models (MLLMs) and/or computer vision models to analyze the camera feed from the camera components 202 and identify various information, such as nonverbal gestures made by the user and/or QR codes within the captured images.

For instance, the processing components 208 can deploy specialized machine learning models that calculate precise nonverbal hand positioning and gesture characteristics. The processing components 208 of the system 100 process multiple sequential frames to distinguish between different gesture types, using advanced algorithms to determine hand angles relative to the camera’s field of view. An optional dual-camera configuration could enable precise depth measurements through stereo vision, while machine learning models filter out unintentional movements and potential interference from third parties.

The processing components 208 of the system 100 can also segment the visual data to isolate regions containing potential QR codes, using bounding box detection to precisely locate the codes’ positions through X-Y coordinate mapping. For each detected QR code, the system 100 validates the code structure and embedded data format against pre-defined payment-specific patterns to ensure only legitimate payment QR codes are processed. This multi-step validation process helps prevent the system 100 from accidentally processing non-payment QR codes that may be visible in the environment.

The communication components 210 enable wireless connectivity for the point-of-sale device 108 interaction and network communication with the server computer 104. These communication components 210 can support various interaction methods including Bluetooth or NFC connectivity for direct connection to the point-of-sale device 108 and network interfaces for processing payment information through vendor and financial institution APIs at the server computer 104.

The sensor components 212 can include proximity sensors and positioning devices for geolocation verification and fraud prevention. These sensor components 212 work together to verify device location (e.g., wearable device 102), check proximity to payment terminals (e.g., point-of-sale device 108), and validate transaction security by confirming vendor attributes and locations. The sensor components 212 also help detect when the wearable device 102 is removed from the user’s body, triggering additional authentication requirements.

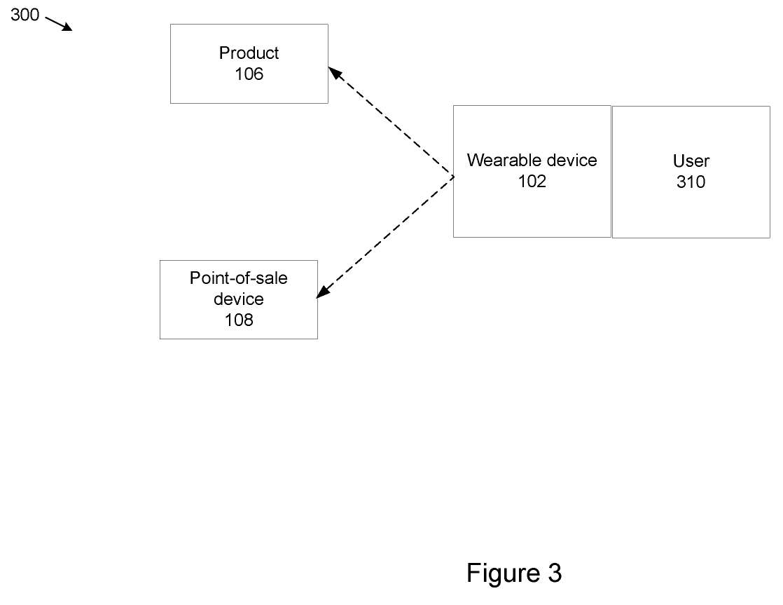

FIG. 3 shows example configurations of the system 100 of FIG. 1.

The wearable device 102 worn by a user 310 interacts with the point-of-sale device 108 and product 106 through several distinct operational modes. When processing payments at a point-of-sale device 108, the system 100 can detect dynamic QR codes displayed on digital screens associated with the point-of-sale device 108, which may contain embedded transaction details, vendor identification, and payment processing information. Alternatively, the point-of-sale device 108 may present static QR codes on printed materials at the cashier station or establish direct wireless connectivity with the wearable device 102 through Bluetooth communications and/or the server computer 104.

For product identification scenarios, the wearable device 102 employs multiple recognition methods based on the type of product 106 being observed. With physical retail items, the wearable device 102 scans for visible price tags or embedded RFID tags, while for restaurant transactions, the system 100 processes printed materials through optical character recognition to extract payment details from menus, bills, or invoices. The system 100 can also identify business establishments by processing storefront signage and validating the detected information against known vendor locations.

The interaction between the user 310 and the system 100 may involve sophisticated positioning verification. As the user 310 points toward either a product 106 or point-of-sale device 108, the wearable device 102 continuously monitors spatial relationships through its proximity sensors and positioning systems. This enables the system 100 to verify transaction security by confirming the relative positions of all components and validating that the detected vendor attributes match known database records. For instance, the wearable device 102 identifies one or more nonverbal gestures made by the user 310 to initiate and/or confirm a transaction, as described further herein.

The point-of-sale device 108 supports various payment processing states through visual indicators that communicate transaction status to both the user 310 and backend systems. These indicators can include customized payment markers that embed unique transaction identifiers, allowing the system 100 to properly associate specific sales with the user 310 while maintaining transaction security. For permanent retail installations, the point-of-sale device 108 can integrate with the store’s positioning infrastructure to enable seamless customer identification and payment processing as the user 310 moves through the space.

The system 100 implements multiple fraud prevention measures during these interactions. When the user 310 initiates a transaction, the wearable device 102 verifies that other known devices show matching location data, confirms that observed environmental details align with known vendor attributes, and validates that the detected location corresponds to the vendor’s registered address. These security measures work in concert with the authentication components 206 to ensure transaction integrity.

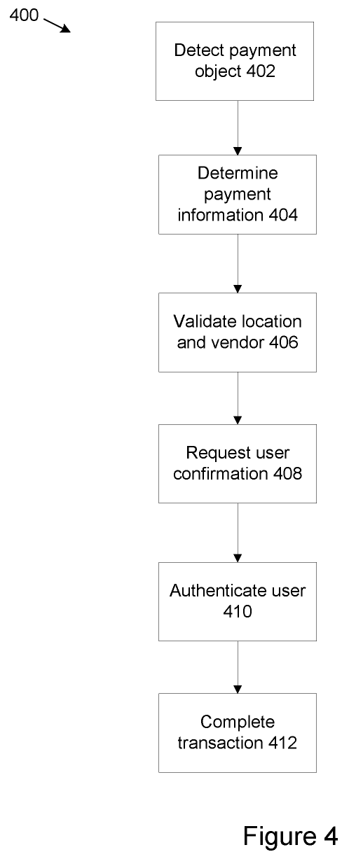

FIG. 4 shows an example method 400 of payment initiation and completion using the system 100 of FIG. 1.

At step 402 (detect payment object), the wearable device 102 uses the camera components 202 to detect when the user 310 initiates a transaction using a nonverbal gesture. For instance, this can include the user 310 pointing at a payment object, like the product 106, through sophisticated computer vision processing. As noted, system 100 can employ specialized machine learning models to calculate hand angles relative to the camera’s field of view, ensuring accurate detection of intentional pointing gestures while reducing false positives.

At step 404 (determine payment information), the processing components 208 employ one or more models to construct payment details based on the type of object detected. For POS terminals like the point-of-sale device 108, the system 100 can read dynamic QR codes displayed on screens, process static QR codes from printed materials, or establish wireless connectivity via Bluetooth. When processing bills or menus, the system 100 can perform OCR to extract payment information, while for physical retail items, it can detect price tags, RFID tags, or perform direct object recognition. The system 100 can also leverage geolocation data and vendor APIs to fill in any missing transaction details.

More specifically, the determination of payment information at step 404 can include determining the list of payment information fields that are required to execute the transaction at hand, and determining which fields are already known and which are yet unknown. This can then include acquiring data to fill the unknown fields, which can be used to create the payment object that is constructed intelligently by the processing components 208 to fill in any gaps.

At step 406 (validate location and vendor), the sensor components 212 can implement an optional security verification process. The system 100 verifies that the user’s other known devices (e.g., smart phone, tablet computer, etc.) show matching location data, confirms that objects visible in the camera view match known vendor attributes, and/or validates that the detected location corresponds to the vendor’s registered address. For permanent store installations, the point-of-sale device 108 works with the positioning infrastructure to enable seamless vendor identification and transaction security.

At step 408 (request user confirmation), the audio components 204 optionally deliver private confirmation prompts through directional speakers. The system 100 maintains user privacy while clearly communicating transaction details, such as payment amounts and vendor information. The point-of-sale device 108 can simultaneously display visual indicators showing transaction status and embedded transaction identifiers that allow proper association with the specific user.

At step 410 (authenticate user), the authentication components 206 processes user confirmation through multiple possible methods. For basic transactions, the camera components 202 can detect another nonverbal gesture, such as a thumbs-up gesture or nod/shake of the head, while higher security transactions may require palm authentication. The palm authentication process can utilize IR cameras for vein pattern detection and depth sensors for accurate positioning, with sophisticated anti-spoofing measures that can detect attempts to use photographs rather than actual palms.

At step 412 (complete transaction), the communication components 210 coordinate with multiple systems to finalize the payment. The system 100 can process the transaction through vendor and financial institution APIs, validate payment methods, and confirm successful completion. The point-of-sale device 108 updates its display to show transaction success, while the audio components 204 optionally can provide confirmation to the user 310. The system 100 maintains transaction security by embedding unique identifiers that properly associate the completed sale with the authenticated user while ensuring all fraud prevention measures remain active.

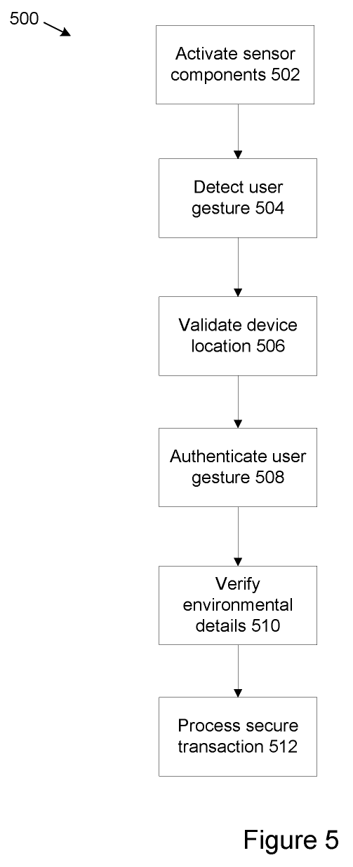

FIG. 5 shows an example method 500 including gesture detection and fraud prevention measures implemented by the system 100 of FIG. 1.

At step 502 (activate sensor components), the wearable device 102 initiates a sensor activation sequence. The camera components 202 begin capturing visual data (e.g., at a calibrated 2-4 frames per second), balancing responsive detection with power efficiency. The system 100 can optionally activate other sensors (e.g., IR cameras, depth sensors, and ToF sensors) to enable enhanced authentication capabilities through stereo vision calculations and sophisticated biometric detection. The sensor components 212 initialize proximity and positioning systems while establishing baseline environmental parameters for fraud prevention.

At step 504 (detect user gesture), the processing components 208 deploy specialized machine learning models that calculate precise hand positioning and gesture characteristics. The system 100 processes multiple sequential frames to distinguish between different gesture types, using advanced algorithms to determine hand angles relative to the camera’s field of view. The dual-camera configuration enables precise depth measurements through stereo vision, while machine learning models filter out unintentional movements and potential interference from third parties.

At step 506 (validate device location), the sensor components 212 perform an optional multi-layered location verification process. The system 100 triangulates position using GPS coordinates, proximity sensors, and wireless connectivity signals to establish precise spatial relationships between the wearable device 102 and payment terminals. For permanent retail installations, the system 100 integrates with existing positioning infrastructure while continuously monitoring relative positions of all system components to maintain security throughout the transaction. The point-of-sale device 108 can provide additional validation through embedded positioning systems.

At step 508 (authenticate user gesture), the authentication components 206 executes biometric validation protocols. For palm authentication, the system 100 optionally combines IR imaging for vein pattern detection with depth sensing for precise positioning, while implementing anti-spoofing measures that can detect attempted fraud through photographs or replicas. The system 100 can process palm prints and vein patterns through encrypted channels, while optionally enabling enhanced security through simultaneous visible light and IR authentication.

t step 510 (verify environmental details), the camera components 202 and sensor components 212 perform environmental validation. The system 100 analyzes visual scenes against known vendor attributes stored in secure databases, while simultaneously verifying location data from multiple connected devices. The processing components 208 execute comparison algorithms to validate that all observed environmental parameters match expected values for the transaction location. These security measures can integrate with positioning systems to create a multi-layered fraud prevention framework.

At step 512 (process secure transaction), the communication components 210 orchestrate secure payment processing through multiple authenticated channels. The system 100 generates unique transaction identifiers that securely link the authenticated user, validated location, and verified vendor details. The point-of-sale device 108 maintains continuous communication with the wearable device 102 throughout the transaction, while the audio components 204 provide private transaction status updates through directional audio. The system 100 can maintain active fraud prevention measures until final transaction confirmation, ensuring security throughout the entire payment process.

There are many alternative embodiments for the system 100 that are possible.

In some embodiments, the wearable device 102 can support multiple alternative authentication configurations beyond its primary nonverbal gesture-based interactions. For example, users can tap sensors integrated into the glasses frame of the wearable device 102 to provide input and transaction confirmation, offering a discrete interaction method that maintains the system’s nonverbal operation.

While the system 100 optionally includes voice recognition capability for directing the wearable device through voice commands, a voice command option can serve as a backup authentication method when other approaches may not be suitable, with the system maintaining its ability to process verbal confirmations like saying “yes” to approve transactions.

The system 100 can also process nonverbal drawing gestures on a screen as an alternative authentication method. This option provides an additional layer of authentication flexibility while maintaining the system’s core security features, including geolocation verification and proximity sensing. Such alternative authentication methods work in conjunction with the system’s fraud prevention measures and can trigger additional authentication requirements if the device detects it has been removed from the user’s head.

Further, the wearable device 102 can be used to facilitate seller-initiated transactions through a modified version of the point-to-pay workflow. In selling scenarios, the seller initiates the transaction through similar nonverbal gestures, allowing the system to identify and validate the potential buyer through its computer vision and authentication systems.

For instance, the selling process begins when the seller points at a potential buyer, prompting the wearable device 102 to identify that person and determine their eligibility as a buyer through its authentication systems. The system 100 can leverage the authentication components 206 and the sensor components 212 to verify the buyer’s identity and establish secure communication channels between the buyer’s and seller’s respective devices.

During the transaction, both buyer and seller can each respectively use their wearable device 102 to engage in negotiation through predefined gestures. The camera components 202 and processing components 208 interpret these negotiation gestures using the same sophisticated machine learning models and computer vision processing that enable payment confirmation gestures. The system 100 maintains security throughout the negotiation process by continuously validating the location and identity of both parties.

The selling workflow can accommodate various transaction types, including direct person-to-person payments similar to Zelle transfers and more complex transactions such as vehicle sales, where the system 100 can use additional verification methods (like license plate recognition, as described below). Throughout the process, the system 100 can maintain its core security features, including geolocation verification, proximity sensing, and biometric authentication when required for higher-value transactions.

There are many addition use cases for the disclosed technologies. For example, as previously noted, the wearable device 102 can facilitate person-to-person payments similar to Zelle transfers by enabling direct transactions between individuals through the point-to-pay system. Users can initiate these transfers by pointing at another person, with the system leveraging its authentication and security features to verify both parties’ identities and process the payment securely.

For vehicle sales scenarios, the system 100 can enhance the transaction process by incorporating license plate recognition capabilities. When processing a vehicle sale, the wearable device 102 can use its camera components 202 and processing components 208 to capture and verify the vehicle’s license plate information as part of the transaction documentation. This additional verification layer helps ensure the accuracy and legitimacy of the vehicle sale transaction.

The system 100 can integrate with vendor databases to access and utilize frequent shopper information during transactions. When processing payments, the communication components 210 can interface with vendor APIs to retrieve the user’s preferred payment methods and frequent shopper details stored in the vendor’s database. This integration enables a more personalized transaction experience while maintaining the system’s security protocols through the authentication components 206 and sensor components 212.

The wearable device 102 can maintain its core security features across all these use cases, including geolocation verification, proximity sensing, and biometric authentication when required for higher-value transactions. The system 100 continues to validate transaction security by verifying device locations, checking environmental attributes, and confirming user identity through gesture-based or palm authentication methods.

Further, in some embodiments, the wearable device 102 can implement enhanced security features that leverage multiple verification systems working in concert. When a user initiates a transaction, the system 100 verifies that the user’s other known devices show matching location data, providing an additional layer of authentication by confirming the user’s presence through multiple independent devices

The camera components 202 and processing components 208 work together to analyze the visual scene and validate vendor authenticity. The system 100 performs real-time comparison of objects visible in the camera view against known vendor attributes stored in secure databases, ensuring that the physical environment matches expected characteristics for the transaction location. This visual validation works in conjunction with the positioning systems to create a comprehensive fraud prevention framework.

For some vendors, such as mobile vendors like food trucks, the system 100 can incorporate additional verification by validating vendor locations against their social media presence. The system 100 can check the detected location against posted coordinates, such as locations announced through vendor tweets, providing another layer of verification for temporary or mobile payment scenarios. These security measures integrate with other fraud prevention features, including proximity sensing and biometric authentication, to maintain transaction integrity throughout the payment process.

The multi-layered security approach combines continuous monitoring of spatial relationships through proximity sensors, validation of vendor attributes through visual processing, and verification of location data from multiple sources to ensure comprehensive transaction security. The system 100 maintains active fraud prevention measures until final transaction confirmation, with the point-of-sale device 108 providing additional validation through its embedded positioning systems.

In addition, various technological enhancements are possible. For example, in other embodiments, the use of QR codes and/or tags could be minimized through advanced visual processing. With more robust hardware capable of constant video streaming for local telemetry processing and equipped with ToF or depth sensors, the system 100 could identify vendor accounts using a combination of positioning data and visual scene understanding. This enhancement would be particularly effective for permanent point-of-sale locations, though portable POS scenarios would still benefit from proximity sensor data.

A vendor onboarding process could incorporate a new visual mapping protocol, where vendors take pictures of the surrounding areas near their point-of-sale locations. These images serve as visual markers that the system 100 can use to identify and verify vendor locations without requiring traditional QR codes or tags. The combination of these visual markers with positioning data would enable more accurate and secure vendor identification during transactions.

Enhanced security features could leverage dual-camera configurations, as described above, on both sides of the glasses, with one camera incorporating either a ToF sensor or IR camera. This hardware enhancement enables more sophisticated authentication through stereo vision calculations, providing more accurate depth measurements for gesture validation and initial setup measurements. The inclusion of an IR camera could allow for more accurate palm vein authentication, while the system 100 could also implement either finger or palm authentication methods for enhanced security. The dual-camera setup could provide more precise biometric data capture and improved spoofing prevention through simultaneous visible light and IR authentication.

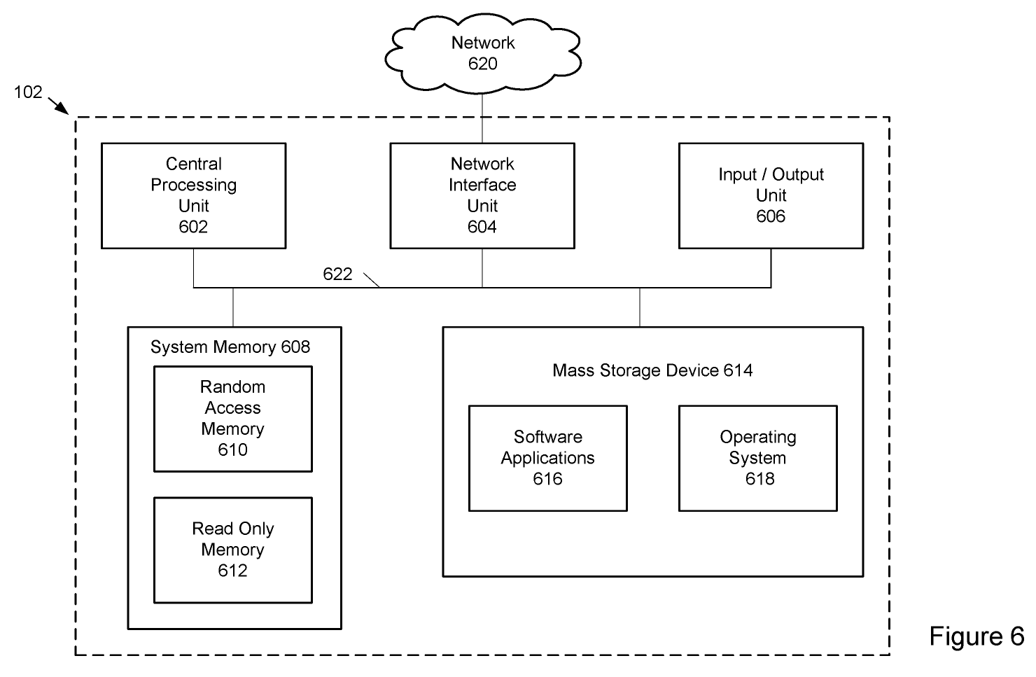

As illustrated in the example of FIG. 6, the example wearable device 102 includes at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the wearable device 102, such as during startup, is stored in the ROM 612. The wearable device 102 further includes a mass storage device 614. The mass storage device 614 is able to store software instructions and data. A central processing unit, system memory and mass storage device similar to that in FIG. 6 are also included in server computer 104.

The mass storage device 614 is connected to the CPU 602 through a mass storage controller (not shown) connected to the system bus 622. The mass storage device 614 and its associated computer-readable data storage media provide non-volatile, non-transitory storage for the wearable device 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and that can be accessed by the wearable device 102.

According to various embodiments of the invention, the wearable device 102 may operate in a networked environment using logical connections to remote network devices through the network 620, such as a wireless network, the Internet, or another type of network. The wearable device 102 may connect to the network 620 through a network interface unit 604 connected to the system bus 622. It should be appreciated that the network interface unit 604 may also be utilized to connect to other types of networks and remote computing systems. The wearable device 102 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the wearable device 102 can store software instructions and data. The software instructions include an operating system 618 suitable for controlling the operation of the wearable device 102. The mass storage device 614 and/or the RAM 610 also store software instructions, that when executed by the CPU 602, cause the wearable device 102 to provide the functionality of the wearable device 102 discussed in this document. For example, the mass storage device 614 and/or the RAM 610 can store software instructions that, when executed by the CPU 602, cause the wearable device 102 to display received financial data on the display screen of the wearable device 102.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system for processing a transaction, the system comprising:
at least one processor; and
memory encoding instructions which, when executed by the at least one processor, causes the system to:
detect, by a wearable device, a nonverbal gesture directed at a payment object;
determine, by the wearable device after detection of the nonverbal gesture, payment information based on computer vision analysis of the payment object;
request, by the wearable device, a confirmation gesture; and
process the transaction in response to the confirmation gesture.

2. The system of claim 1, comprising further instructions which, when executed by the at least one processor, causes the system to:
verify locations of other devices associated with a user match a detected location of the wearable device,
confirm objects visible to the wearable device match attributes of a vendor associated with the payment object, and
validate the detected location corresponds to an address of the vendor.

3. The system of claim 1, wherein the wearable device comprises:
a camera configured to capture the nonverbal gesture; and
a speaker configured to provide audio feedback.

4. The system of claim 3, further comprising:
one or more depth sensors configured for palm placement detection; and
an infrared camera for palm vein detection.

5. The system of claim 1, comprising further instructions which, when executed by the at least one processor, causes the system to process a code displayed on a point-of-sale terminal to determine the payment information.

6. The system of claim 1, wherein the confirmation gesture includes:
a physical gesture for basic transactions; and
palm authentication for higher security transactions, wherein the palm authentication includes to:
capture palm vein patterns using an infrared camera;
validate palm positioning using depth sensors; and
implement anti-spoofing measures to detect attempted fraud.

7. The system of claim 1, wherein the wearable device does not provide visual feedback to a user.

8. The system of claim 1, comprising further instructions which, when executed by the at least one processor, causes the system, during establishment of baseline measurements, to:
capture multiple images of hand positions;
calculate hand angles relative to a camera; and
process biometric data through both visible light and infrared sensing.

9. The system of claim 1, wherein the payment object comprises one or more of:
a point-of-sale terminal displaying payment information;
a printed bill or menu;
a physical retail item; and
a business establishment.

10. The system of claim 1, wherein the wearable device comprises:
smart glasses;
a pocket-clipped camera device;
a pendant-style wearable; or
a lapel-mounted camera device.

11. The system of claim 1, comprising further instructions which, when executed by the at least one processor, causes the system to authenticate a user through detection of the confirmation gesture.

12. The system of claim 1, wherein the request for the confirmation gesture is audial.

13. A method for processing a transaction, the method comprising:
detecting, by a wearable device, a nonverbal gesture directed at a payment object;
determining, by the wearable device after detection of the nonverbal gesture, payment information based on computer vision analysis of the payment object;
requesting, by the wearable device, a confirmation gesture;
authenticating a user through detection of the confirmation gesture; and
processing the transaction upon successful authentication.

14. The method of claim 13, further comprising:
verifying locations of other devices associated with the user match a detected location of the wearable device,
confirming objects visible to the wearable device match attributes of a vendor associated with the payment object, and
validating the detected location corresponds to an address of the vendor.

15. The method of claim 13, wherein the wearable device comprises a camera configured to capture the nonverbal gesture.

16. The method of claim 15, further comprising:
one or more depth sensors configured for palm placement detection; and
an infrared camera for palm vein detection.

17. The method of claim 13, further comprising processing a code displayed on a point-of-sale terminal to determine the payment information.

18. The method of claim 13, wherein the confirmation gesture includes:
a physical gesture for basic transactions; and
palm authentication for higher security transactions.

19. The method of claim 18, further comprising:
capturing palm vein patterns using an infrared camera;
validating palm positioning using depth sensors; and
implementing anti-spoofing measures to detect attempted fraud.

20. The method of claim 13, further comprising:
capturing multiple images of hand positions;
calculating hand angles relative to a camera; and
processing biometric data through both visible light and infrared sensing.
